(19) United States
(12) Patent Application Publication
(10) Pub. No.: US 2023/0151733 A1
(43) Pub. Date: May 18, 2023

(54) DISK CUTTER

(71) Applicant: Element Six (UK) Limited, Didcot, Oxfordshire (GB)

(72) Inventor: Shuo Lu, Didcot (GB)

(73) Assignee: Element Six (UK) Limited, Didcot, Oxfordshire (GB)

(21) Appl. No.: 17/995,535

(22) PCT Filed: Apr. 6, 2021
(86) PCT No.: PCT/EP2021/058877

§ 371 Date: Oct. 5, 2022

(30) Foreign Application Priority Data
Apr. 6, 2020 (GB) 2005021.7

(51) Int. Cl. E21C 35/183; E21C 25/18

(52) U.S. Cl. CPC E21C 35/1835; E21C 25/18; E21C 35/1831; E02F 5/08

(57) ABSTRACT

This disclosure relates to a disk cutter (100) for a cutting assembly of a rock excavation machine. The disk cutter comprising a cutter body (102) including at least one light-weighting aperture (110).

### FIELD OF THE INVENTION

The present disclosure relates to a disk cutter for use in mining and excavation machines or in trenching machines. In particular, it relates to a disk cutter with cutting elements comprising superhard materials, such as polycrystalline diamond.

### BACKGROUND

Many types of rock formations are available around the world as large deposits, commonly known as slabs. Various types of mining equipment are deployed in above ground quarries in order to extract the slabs from the ground. The slabs are retrieved using specialist equipment, typically dragged from their resting place by large and very powerful vehicles. Rock slabs may weigh up to 40 tons (40,000 kg). Processing, such as polishing, may take place on site, or alternatively the slabs may be transported off site for cutting into appropriately sized pieces for domestic and industrial use.

Providing a compact and versatile cutting assembly to facilitate the mining and extraction of geometrically or non-geometrically shaped blocks of specific rock formations is challenging.

The Applicant's co-pending applications WO 2019/180164 A1, WO 2019/180169 A1, WO 2019/180170 A1 disclose a cutting assembly comprising a circular disk cutter, which is moveable between horizontal and vertical cutting orientations. Cylindrical cutting elements and a corresponding quantity of tool holders are arranged and seated around a circumferential surface of the disk cutter. Each tool holder may be at least partially laterally offset with respect to the circular body.

It is an object of the invention to provide a super-compact cutting assembly particularly suitable for robotic application.

### SUMMARY OF THE INVENTION

In accordance with a first aspect of the invention, there is provided a disk cutter for a cutting assembly of a rock excavation machine, the disk cutter comprising a cutter body with a diameter of less than 500 mm, the cutter body including at least one light-weighting aperture, a plurality of tool holders mounted in succession along a peripheral surface of the cutter body, and a cutting element mounted to at least one of the plurality of tool holders, wherein the total mass of the disk cutter is less than 5 kg.

This arrangement is particularly advantageous for use in a robotic cutting assembly. Activity may take place underground but the robotic cutting assembly may be operated remotely from above ground. This minimises local human involvement, rendering cutting operations safer. Thanks to the reduced weight, the cutting assembly is nimble and easy to manoeuvre from afar.

Preferably, the cutter body comprises a plurality of light-weighting apertures. The cutter body may comprises more than three light-weighting apertures. For example, the cutter body may comprise four, five or six light-weighting apertures.

Optionally, the cutter body comprises a drive spindle aperture for receiving a drive spindle and a plurality of spokes, one of said plurality of light-weighting apertures being located between a pair of adjacent spokes.

The drive spindle aperture may be located radially offset from a centre of the body. Alternatively, the drive spindle aperture may be located radially centrally.

Preferably, the plurality of spokes extend radially outwardly from the drive spindle aperture. The plurality of spokes may be arranged asymmetrically about the driver spindle aperture. Alternatively, the plurality of spokes may be arranged symmetrically about the driver spindle aperture.

Preferably, the spokes taper from a first end towards a second end. Optionally, the second end is located at or near a peripheral surface of the body.

The cutter body may comprise a series of slots.

In an embodiment, the cutter body has a diameter of less than 450 mm. Preferably, the cutter body has a diameter of between 200 and 400 mm.

Preferably, the cutter body comprises aluminium alloy.

Optionally, the tool holder comprises a body portion and a pair of spaced apart legs extending from the body portion that sit astride the cutter body.

Optionally, a single cutting element is mounted in a tool holder. The single cutting element may be mounted centrally on the tool holder.

Optionally, two cutting elements are mounted in a tool holder. The two cutting elements may be arranged spaced apart from each other on the tool holder.

Optionally, the two cutting elements point outwardly from the plane of the cutter body.

Preferably, the cutting element comprises polycrystalline diamond (PCD). The cutting element may be a polycrystalline diamond compact (PDC).

Preferably, the total mass of the disk cutter is less than 3 kg.

In accordance with a second aspect of the invention, there is provided a robotic cutting assembly for a rock excavation machine comprising a disk cutter in accordance with the first aspect of the invention.

### BRIEF DESCRIPTION OF THE DRAWINGS

The invention will now be more particularly described, by way of example only, with reference to the accompanying drawings, in which

FIG. 1 is a schematic plan view of an underground mine incorporating a first variant of a known cutting assembly as part of a long wall mining system, and in particular shows the cutting assembly in a horizontal orientation;

FIG. 2 is a schematic end view of the long wall mining system of FIG. 1;

FIG. 3 is a schematic plan view of an underground mine incorporating a second variant of a known cutting assembly as part of a long wall mining system, and in particular shows the cutting assembly in a vertical orientation;

FIG. 4 is schematic end view of the long wall mining system of FIG. 3;

FIG. 5 is a perspective view of a disk cutter in a first embodiment of the invention, with a generally circular cutter body, a plurality of tool holders mounted to the disk cutter and a cutting element secured to each tool holder;

FIG. 6 is a side view of the disk cutter of FIG. 5;

FIG. 7 is a side view of a first embodiment of a tool holder and cutting element forming part of the disk cutter of FIG. 5;

FIG. 8 is a front view of the tool holder and cutting element of FIG. 7;

FIG. 9 is a side view of a second embodiment of a tool holder and cutting element;

FIG. 10 is a front view of the tool holder and cutting element of FIG. 9;

FIG. 11 is a side view of a second embodiment of the cutter body;

FIG. 12 is a side view of a third embodiment of the cutter body;

FIG. 13 is a side view of a fourth embodiment of the cutter body;

FIG. 14 is a perspective view of a disk cutter in a second embodiment of the invention;

FIG. 15 is a side view of the disk cutter of FIG. 14;

FIG. 16 is a perspective view of a third embodiment of a tool holder and cutting element;

FIG. 17 is a side view of the tool holder and cutting element of FIG. 16; and

FIG. 18 is a front view of the tool holder and cutting element of FIG. 16.

In the drawings, similar parts have been assigned similar reference numerals.

### DETAILED DESCRIPTION

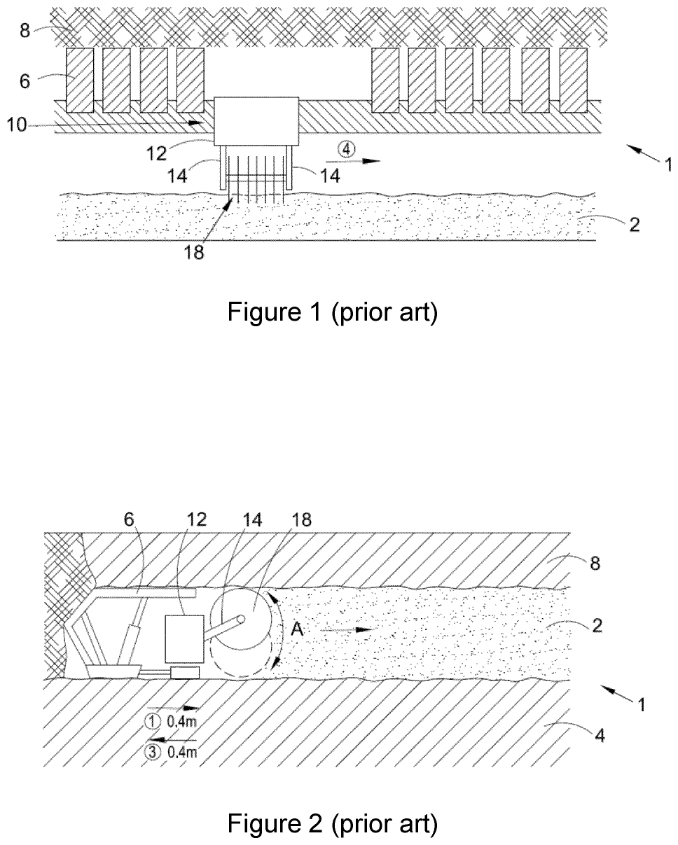

Referring initially to FIGS. 1 to 2, a known cutting assembly for slicing into natural formations 2 underground is indicated generally at 10.

The cutting assembly forms part of a long wall mining system 1, commonly found in underground mines. The cutting assembly is a substitute for known shearer technology, which operates on a mine floor 4, amidst a series of adjustable roof supports 6. As the shearer advances in the direction of mining, the roof supports 6 are positioned to uphold the mine roof 8 directly behind the shearer. Behind the roof supports 6, the mine roof 6 collapses in a relatively controlled manner. Typically, a gathering arm collects mined rock at the cutting face and transfers it onto a conveying system for subsequent removal from the mine.

As indicated in FIGS. 1 and 2, the cutting assembly 10 comprises a base unit 12, a pair of spaced apart support arms 14 extending from the base unit 12, a drive spindle 16 extending between and rotatably mounted to the pair of moveable support arms 14, and a plurality of disk cutters 18 fixed about the drive spindle 16.

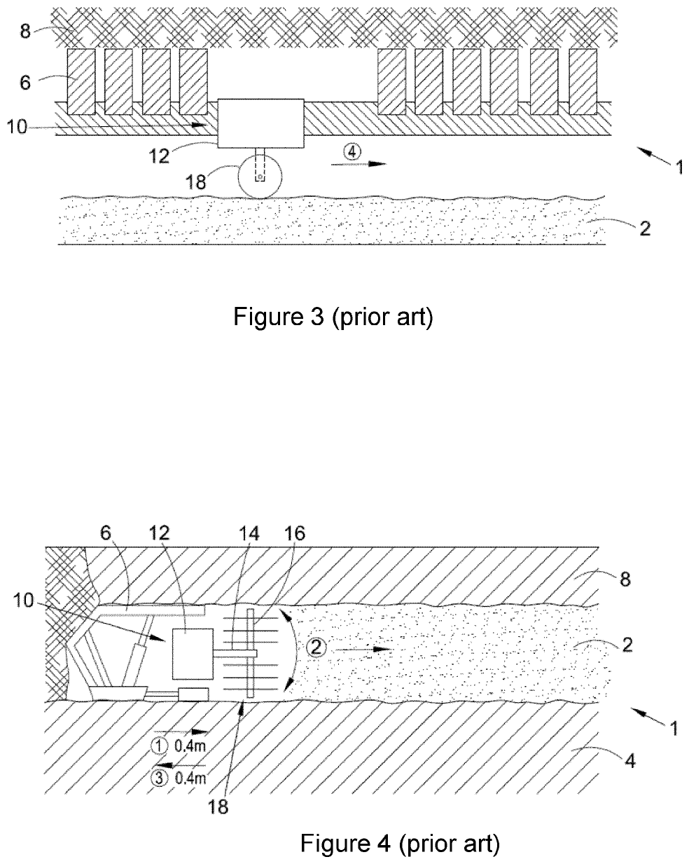

In a second known cutting assembly, indicated in FIGS. 3 and 4, a single support arm 14 extends from the base unit 12. The drive spindle 16 is supported centrally by the single support arm 14, and the plurality of disk cutters 18 is mounted to the drive spindle 16, distributed either side of the single support arm 14.

The or each disk cutter 18 is typically mounted at is centre (i.e. centrally) about the drive spindle 16.

The base unit 12 functions as a transport system for the disk cutter 18. The base unit 12 is moveable to advance and retract the disk cutter 18 into and out of an operational position, in close proximity to the rock formation 2 to be cut. The speed at which the base unit 12 moves closer to the rock formation 2 is one of several variables determining the feed rate of the cutting assembly 10 into the rock formation 2. The base unit 12 (in concert with the roof supports 6) is also moveable sideways, from left to right and vice versa, along the long wall of the rock formation 2 to be mined.

Each support arm 14 is configured to be moveable into a first and a second cutting orientation. In the first cutting orientation, best seen in FIGS. 1 and 2, the drive spindle 16 is horizontal. As a result, cuts in the rock formation 2 made by the disk cutter 18 are correspondingly vertical. In the second cutting orientation, best seen in FIGS. 3 and 4, the drive spindle 16 is vertical. Consequently, cuts in the rock formation 2 made by the disk cutter 18 are correspondingly horizontal. First and second cutting orientations are possible with either first or second embodiments mentioned above.

The support arm(s) 14 may also be moveable such that the drive spindle 16 is operable in any cutting orientation between the aforementioned vertical and horizontal, though this is not essential. The support arm(s) 14 may alternatively be configured such that they are moveable between the first and second cutting orientations but only fully operational (i.e. the disk cutter(s) to rotate in order to facilitate cutting or pulverising of the rock) in the first and second cutting orientations.

Each support arm 14 is moveable between a first operative position and a second operative position, in optionally each of the first and second cutting orientations, according to the depth of cut required. This is indicated by double end arrow A in FIG. 2. For example, in the first operative position, the drive spindle 16 is lowered so as to be in close proximity to the mine floor 4 and in the second operative position, the drive spindle 16 is raised so as to be in close proximity to the mine roof 8.

Each support arm 14 may have a first arm portion connected to a second arm portion by a pivot joint (or alternatively, a universal joint), each first and second arm portion being independently moveable relative to each other. This arrangement augments the degrees of freedom with which the cutting assembly 10 may operate and advantageously improves its manoeuvrability.

The drive spindle 16 is driven by a motor to rotate at a particular speed. The power of the motor is typically between 20 and 50 kW per disk cutter 18, depending on the type of disk cutter 18 selected and the cutting force required.

A disk cutter specially adapted for use in a robotic cutter assembly has been devised.

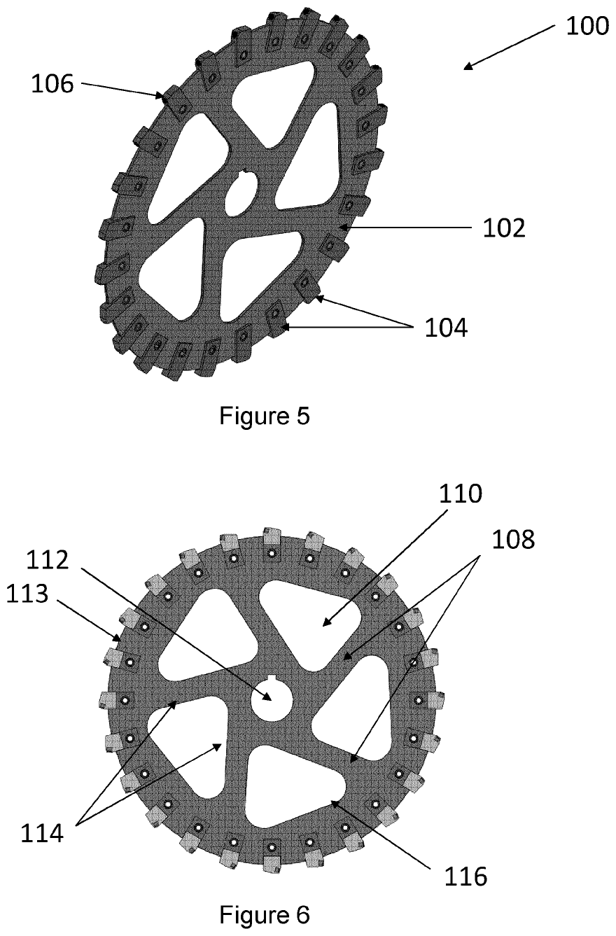

Turning now to FIGS. 5 and 6, in an embodiment of the invention, the disk cutter 100 comprises a circular cutter body 102 and a plurality of tool holders 104 arranged peripherally around the cutter body 102. A single cutting element 106 is mounted in each tool holder 104. Rotation of the drive spindle 16 causes a corresponding rotation of the disk cutter 100.

To minimise the weight of the disk cutter 100, panels have been removed from the cutter body 102 to leave apertures. These apertures extend through the thickness of the cutter body 102. Removing several panels leaves spokes in-between apertures. Typically, these panels are removed by laser, though any form of machining could be used. The pattern of the apertures maintains structural strength whilst reducing the weight of the whole disk. Optimised strength to weight ratios for different applications can be achieved with different geometric designs.

In this embodiment, the cutter body 102 comprises five radial spokes 108 and five light-weighting apertures 110, one aperture 110 between a pair of neighbouring spokes 108. The spokes 108 are regularly spaced apart about a central shaft aperture 112. However, the spokes 108 are off-set centrally and the cutter body 102 is asymmetric about its axis of rotation, the shaft aperture 112. The breadth of the spokes 108 remains largely unchanged from the centre of the cutter body 102 towards a peripheral (or circumferential) surface 113 of the body 102. Each aperture 110 is triangular with rounded corners. Two surfaces 114 of the triangular aperture 110 extend generally radially and a third surface 116 extends generally circumferentially.

The cutter body 102 has a diameter of approximately 421 mm and a thickness of 3 mm. The shaft aperture 112 has a diameter of 10 mm, and is sized and shaped to receive the drive spindle 16. The cutter body 102 is made from aluminium alloy 7068 and weighs approximately 1.47 kg. Were the cutter body 102 to be made from steel, it would weigh approximately 2.58 kg.

In an alternative embodiment, the cutter body has a diameter of less than 500 mm. Preferably, the cutter body has a diameter of less than 500 mm. Preferably, the cutter body has a diameter of between 200 and 400 mm.

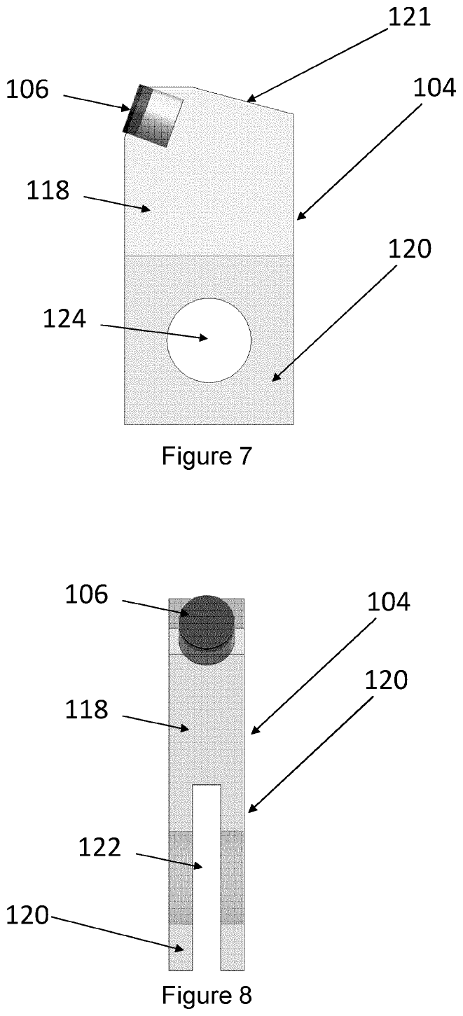

Turning now to FIGS. 7 and 8, twenty-four tool holders 104 are mounted to the cutter body 102. Each tool holder 104 comprises a body portion 118 and a pair of spaced apart legs 120 extending from the body portion 118. The proportion of the lengths of the body portion 118 to the pair of legs 120 is around 1:1. The body portion 118 hosts the cutting element 106. The body portion 118 is generally cuboidal but the height starts to decrease mid-way from front to back to the tool holder 104, such that a head 121 of the tool holder 104 slopes downwardly. The cutting element 106 is inserted into the front of the tool holder 104 at an angle such that the cutting element 106 points upwardly. Each leg 120 of the pair of legs is plate-like. The pair of legs 120 are spaced apart by a gap 122, which enables coupling of the tool holder 104 either side of the cutter body 102. A hole 124, for receiving a bolt, extends through the pair of legs 120.

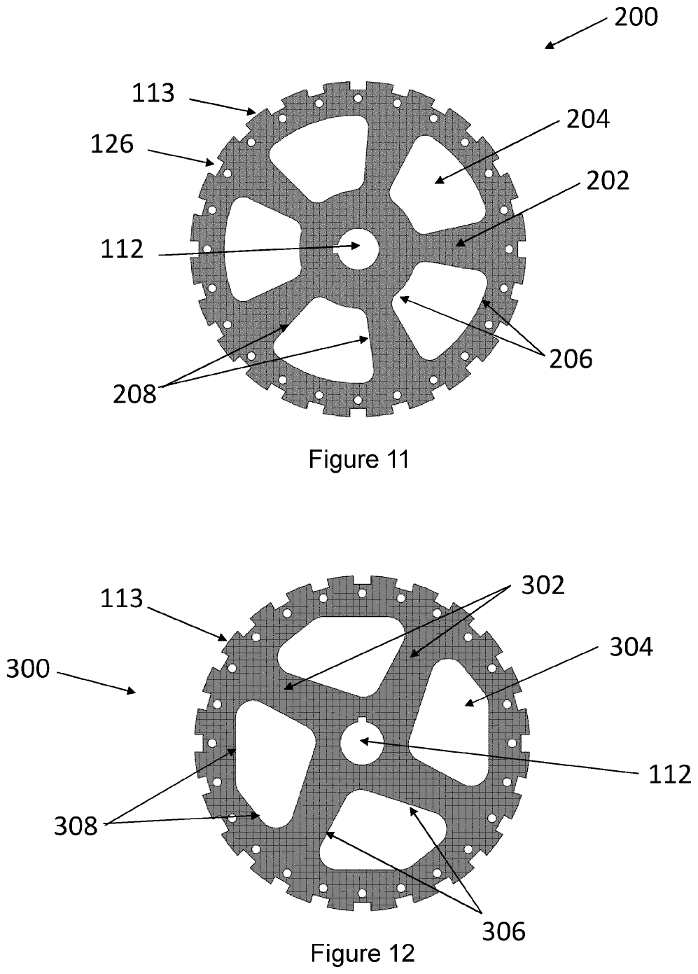

The cutter body 102 comprises a plurality of slots 126, positioned periodically along the peripheral surface 113 of the cutter body 102, best seen in FIGS. 11, 12 and 13. When the tool holder 104 is mounted onto the cutter body 102, the legs 120 pass either side of and adjacent to the cutter body 102 and each body portion 118 sits at least partially within the slot 126. Each tool holder 104 is secured to the cutter body 102 with a nut and bolt (not shown). Alternatively, a permanent connection such as brazing or welding could be used. A mixture of brazing, welding and/or mechanical connections may also be used. Alternatively, the tool holder(s) 104 may be formed integrally with the cutter body 102, for example, by forging, powder metallurgy etc. The slots 126 reduce the shear force on the bolts during use. By virtue of the peripheral surface 113 of the cutter body 102 extending between neighbouring slots 126, tool holders 104 are regularly spaced apart around the cutter body 102.

Each tool holder 104 is made from steel but may alternatively comprise any metal(s) or carbides or ceramic based materials with a hardness above 70 HV (Vickers Hardness). The tool holder 104 may comprise aluminium alloy and comprise the same material as the cutter body 104. The tool holder 104 may comprise carbide, for example, tungsten carbide.

The tool holder in this embodiment has a thickness of approximately 8 mm.

Each cutting element 106 comprises a hard, wear resistant material with a hardness value of 130 HV and above. The cutting element 106 preferably comprises a superhard material selected from the group consisting of cubic boron nitride, diamond, diamond like material, or combinations thereof, but may be a hard material such as tungsten carbide instead. The cutting element 106 may comprise a cemented carbide substrate to which the superhard material is joined.

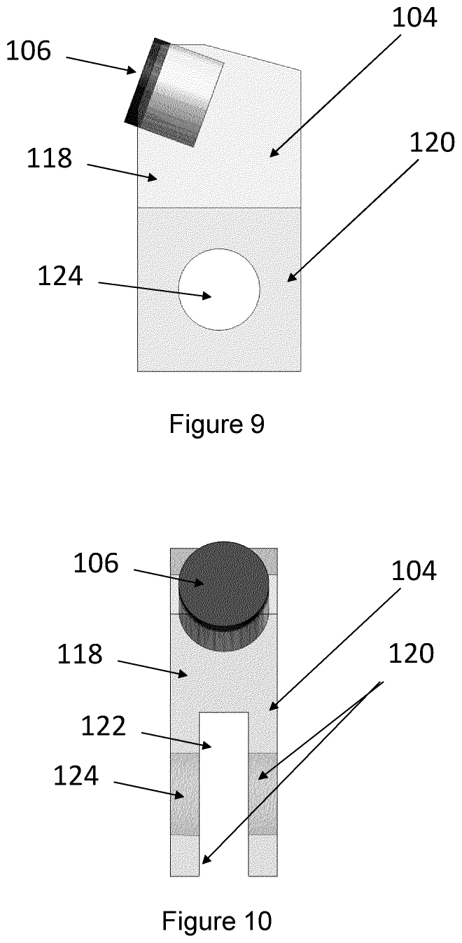

In FIGS. 5 to 10, the cutting elements 106 are polycrystalline diamond compacts (PDCs), more commonly found in the field of Oil and Gas drilling. Such PDCs are often cylindrical and usually comprise a diamond layer sinter joined to a steel or carbide substrate. The PDC has a diameter of between 6 mm and 30 mm, preferably between 8 mm and 25 mm. For example, the PDC may have a diameter of 6 mm, 11 mm, 12 mm, 13 mm, or 16 mm or 19 mm. In FIGS. 5 to 8, the PDC has a diameter of 6 mm. In the embodiment shown in FIGS. 9 and 10, the PDC has a diameter of 12 mm. A combination of diameters may be used in a disk cutter 100. Each PDC may be chamfered, double chamfered or multiple chamfered. Each PDC may comprise a polished cutter surface, or be at least partially polished.

For a PDC with a dimeter of 11 mm, the preferred cutter body has a diameter of 400 mm and a thickness of 6 mm. Again, the cutter body preferably comprises aluminium alloy 7068. Twenty-four tool holders are used to support twenty-four PDCs. Each tool holder has a thickness of 13 mm. The shaft aperture is again 10 mm. The resulting weight of the disk cutter is approximately 2.48 Kg. Were the cutter body to be made from steel, the weight of the whole assembly would be approximately 4.51 Kg.

Optionally, the rake angle of the (PDC-type) cutting element is between 15 degrees and 30 degrees. Optionally, the rake angle is around 20 degrees. Optionally, the rake angle may be positive or negative. FIG. 7 shows how the cutting element 106 protrudes from the tool holder 102.

In rock excavation applications, the disk cutter 100 is brought into contact with the rock formation 2 and rotation of the drive spindle 16, and therefore its disk cutter(s) 100, causes slicing of the rock formation 2. The cutting assembly 10 slices into the rock formation 2, for example, to create clean orthogonal cuts of around 16 mm, depending on the size of the cutting elements 22 selected. The cut rock breakouts either under its own weight or with secondary wedge force, e.g. using a wedge-shaped tool.

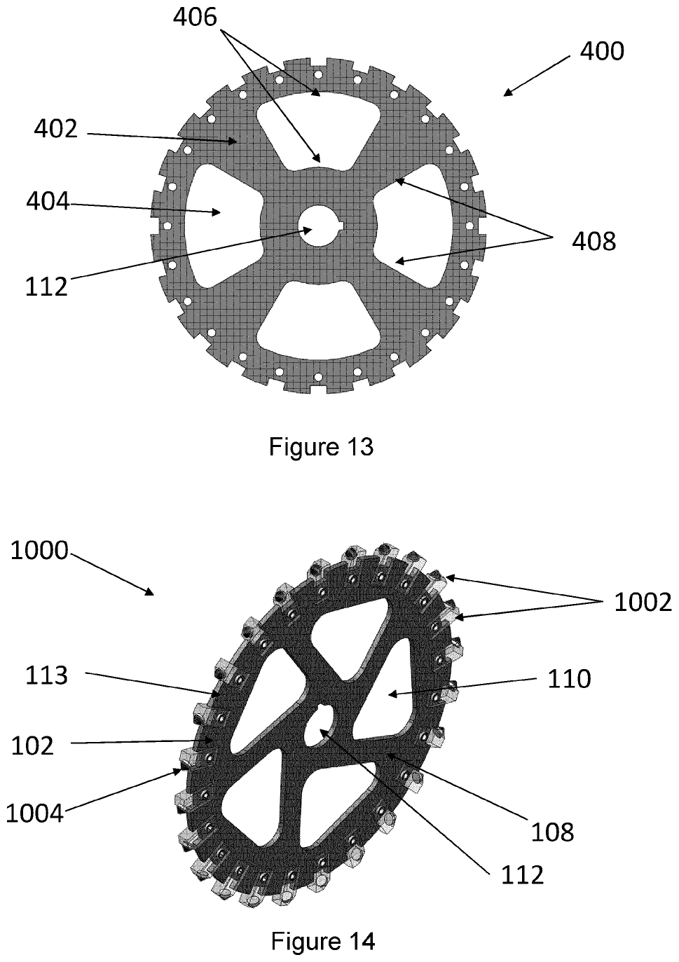

FIGS. 11 to 13 depict an alternative form of cutter body 102, which could be used in any combination with of the features described herein. In FIGS. 12 and 13, four panels have been removed from the body to leave four apertures. Similarly, in FIGS. 5, 6, 11, 14 and 15, five panels have been removed. Typically, these panels are removed by laser, though any form of machining could be used. The pattern of the apertures maintains structural strength whilst reducing the weight of the whole disk. Optimised strength to weight ratios for different applications can be achieved with different geometric designs.

Referring to FIG. 11, a second embodiment of the cutter body is indicated at 200. The body comprises five radial spokes 202 and five light-weighting apertures 204, one aperture 204 between a pair of neighbouring spokes 202. The spokes 202 are regularly spaced apart and symmetrical about the central shaft aperture 112 that receives the drive spindle 16. The spokes 202 taper circumferentially outwardly from the centre of the cutter body 200 towards the peripheral surface 113 of the body 200. As a consequence, each aperture 204 is generally trapezoidal in shape, with a pair of arcuate inner and outer surfaces 206 and a pair of straight surfaces 208 adjoining the arcuate surfaces 206. The arcuate surfaces 206 extend circumferentially, whereas the straight surfaces 208 extend radially.

In FIG. 12, a third embodiment of the cutter body is indicated at 300. The body comprises four radial spokes 302 and four light-weighting apertures 304, one aperture 304 between a pair of neighbouring spokes 302. The spokes 302 are regularly spaced apart about the central shaft aperture 112. However, the spokes 302 are off-set centrally and the body 300 is asymmetric about its axis of rotation, the shaft aperture 112. The breadth of the spokes 302 remains largely unchanged from the centre of the body 300 towards the peripheral surface 113 of the body 300. Each aperture 304 is a quadrilateral, with two adjoining surfaces 306 extending generally radially and an opposing pair of adjoining surfaces 308 extending generally circumferentially.

Referring to FIG. 13, a fourth embodiment of the cutter body is indicated at 400. The body comprises four radial spokes 402 and four light-weighting apertures 404, one aperture 404 between a pair of neighbouring spokes 402. The spokes 402 are regularly spaced apart and symmetrical about the central shaft aperture 112 that receives the drive spindle 16. The spokes 402 taper circumferentially outwardly from the centre of the body 400 towards the peripheral surface 113 of the body 400. As such, each aperture 404 is generally trapezoidal in shape, with a pair of arcuate inner and outer surfaces 406 and a pair of straight surfaces 408 adjoining the arcuate surfaces 406. The arcuate surfaces 406 extend circumferentially, whereas the straight surfaces 408 extend radially.

Rather than being a traditional PDC, the cutting element 106 may be a 3-D shaped cutter. A strike tip of the cutting element 106 may be conical, pyramidal, ballistic, chisel-shaped or hemi-spherical. The strike tip may be truncated with a planar apex, or non-truncated. The strike tip may be axisymmetric or asymmetric. Any shape of cutting element 106 could be used, in combination with any aspect of this invention. Examples of such shaped cutters can be found in WO 2014/049162 and WO 2013/092346.

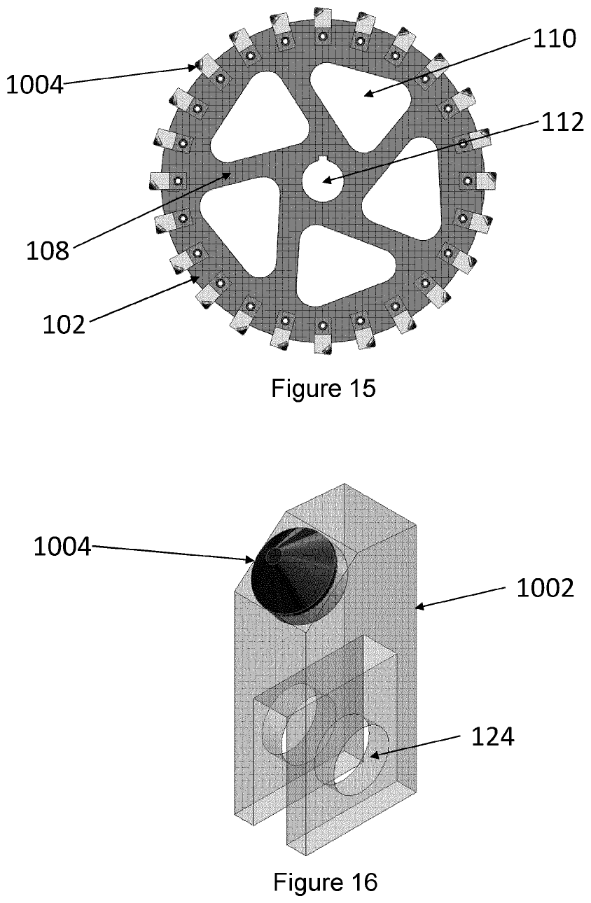

In FIGS. 14 and 15, a second embodiment of a disk cutter is shown. The disk cutter 1000 comprises a generally circular cutter body 102 and a plurality of tool holders 1002 arranged peripherally around the circular body 20. The cutter body 102 is the same as the cutter body of the first embodiment, and so a further description is omitted.

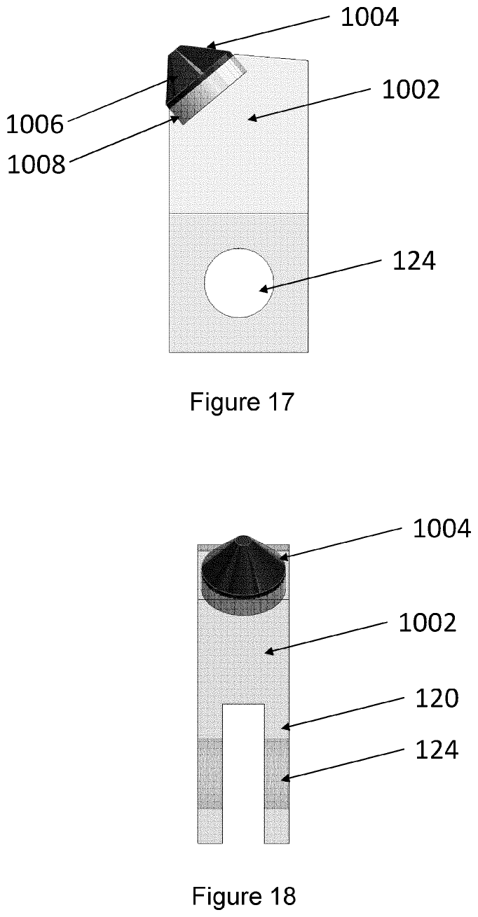

A single cutting element 1004 is coupled to each tool holder 1002. The cutting element 1004 comprises a 3-D shaped cutter, best seen in FIGS. 16 and 17. The cutting element 1004 has a conical strike tip 1006, which is truncated, joined to a carbide substrate 1008. The strike tip 1006 comprises superhard material. A wide base of the cutting element 1004 is firmly seated within a recess of the tool holder 1002, and a free end at the strike tip 1006 points in the intended direction of rotation of the disk cutter 1000, in line with the plane of the cutter body 102—see FIG. 18. The substrate 1008 is sat almost completely within the tool holder 1002 such that the strike tip 1006 projects out of the tool holder 1002—see FIG. 17. In this way, the strike tip 1006 helps to reduce ‘bodywash’ (i.e. erosion) of the tool holder 1002 in use.

In a further embodiment, not shown, two cutting elements 1004 may be provided on the tool holder 1002. These cutting elements 1004 are spaced apart. The two strike tips 1006 still point in the intended direction of rotation of the disk cutter 1000 but their direction is not in line with the plane of the cutter body 1000. They each point outboard, in opposing directions, symmetrical about the plane of the cutter body 1000.

The total mass of the disk cutter 1000 is less than 5 kg.

While this invention has been particularly shown and described with reference to embodiments, it will be understood by those skilled in the art that various changes in form and detail may be made without departing from the scope of the invention as defined by the appended claims.

For example, any embodiment of the cutter body 102, 200, 300, 400, may be used in combination with a PDC cutting element 106 and/or with a 3-D shaped cutter 1004.

For example, the two cutting elements each pointing outboard, in opposing directions, symmetrical about the plan of the cutter body may be PDCs rather than 3-D shaped cutting elements 1004.

Certain standard terms and concepts as used herein are briefly explained below.

As used herein, polycrystalline diamond (PCD) material comprises a plurality of diamond grains, a substantial number of which are directly inter-bonded with each other and in which the content of the diamond is at least about 80 volume percent of the material. Interstices between the diamond grains may be substantially empty or they may be at least partly filled with a bulk filler material or they may be substantially empty. The bulk filler material may comprise sinter promotion material.

1. A disk cutter for a cutting assembly of a rock excavation machine, the disk cutter comprising a cutter body with a diameter of less than 500 mm, the cutter body including at least one light-weighting aperture, a plurality of tool holders mounted in succession along a peripheral surface of the cutter body, and a cutting element mounted to at least one of the plurality of tool holders, wherein the total mass of the disk cutter is less than 5 kg.

2. The disk cutter as claimed in claim 1, wherein the cutter body comprises a plurality of light-weighting apertures.

3. The disk cutter as claimed in claim 1, wherein the cutter body comprises more than three light-weighting apertures.

4. (canceled)

5. The disk cutter as claimed in claim 2, wherein the cutter body comprises a drive spindle aperture for receiving a drive spindle and a plurality of spokes, one of said plurality of light-weighting apertures being located between a pair of adjacent spokes.

6. The disk cutter as claimed in claim 5, wherein the drive spindle aperture is located radially offset from a centre of the body.

7. The disk cutter as claimed in claim 5, wherein the drive spindle aperture is located radially centrally.

8. The disk cutter as claimed in claim 7, wherein the plurality of spokes extend radially outwardly from the drive spindle aperture.

9. The disk cutter as claimed in claim 7, wherein the plurality of spokes are arranged asymmetrically about the driver spindle aperture.

10. The disk cutter as claimed in claim 7, wherein the plurality of spokes are arranged symmetrically about the driver spindle aperture.

11. The disk cutter as claimed in claim 5, wherein the spokes taper from a first end towards a second end.

12. The disk cutter as claimed in claim 11, wherein the second end is located at or near a peripheral surface of the body.

13. The disk cutter as claimed in claim 1, wherein the cutter body comprises a series of slots.

14. The disk cutter as claimed in claim 1, wherein the cutter body has a diameter of less than 450 mm.

15. The disk cutter as claimed in claim 1, wherein the cutter body has a diameter of between 200 and 400 mm.

16. The disk cutter as claimed in claim 1, wherein the cutter body comprises aluminium alloy.

17. The disk cutter as claimed in claim 1, wherein the tool holder comprises a body portion and a pair of spaced apart legs extending from the body portion that sit astride the cutter body.

18. The disk cutter as claimed in claim 1, comprising a single cutting element in each tool holder.

19. The disk cutter as claimed in claim 18, wherein the single cutting element is mounted centrally on the tool holder.

20. disk cutter as claimed in claim 1, comprising two cutting elements in the tool holder.

21. The disk cutter as claimed in claim 20, wherein the two cutting elements are arranged spaced apart from each other on the tool holder.

22. The disk cutter as claimed in claim 21, wherein the two cutting elements point outwardly from the plane of the cutter body.

23. The disk cutter as claimed in claim 1, wherein the cutting element comprises polycrystalline diamond (PCD); and/or wherein the cutting element is a polycrystalline diamond compact (PDC).

24. (canceled)

25. (canceled)

26. A robotic cutting assembly for a rock excavation machine comprising the disk cutter as claimed in claim 1.
